(19) United States
(12) Patent Application Publication
(10) Pub. No.: US 2007/0041194 A1
(43) Pub. Date: Feb. 22, 2007

(54) Searchlight improvement structure

(76) Inventor: Shih-Yung Chiu, Sindian City (TW)

Correspondence Address: BACON & THOMAS, PLLC, 625 SLATERS LANE, FOURTH FLOOR, ALEXANDRIA, VA, 22314, US

(21) Appl. No.: 11/205,070

(22) Filed: Aug. 17, 2005

(51) Int. Cl. F21S 8/12; F21V 19/02; F21V 23/04; F21V 31/00

(52) U.S. Cl. 362/286; 362/267; 362/428; 362/394; 362/526

(57) ABSTRACT

A searchlight improvement structure comprises an electrical cable with a plug and four leads to supply power source to the searchlight, a lamp means mounted in a lamp housing having a vertical drive means for tilting the lamp means in a vertical direction, a base means for mounting the lamp housing having a horizontal drive means for rotating the lamp means in a horizontal direction, a wireless receiver with an antenna inside assembled on the electrical cable with its assembling position outside and away from the lamp housing and the base means, and two separated wireless transmitters each include an on/off switch and a four-way directional control switch, one wireless transmitter is connected by leads of the electrical cable, the other wireless transmitter is powered by a replaceable internal power supply; the searchlight is further provided with a waterproof cover securely assembled on the lamp housing and positioned in front of the lamp means to prevent rain water from seeping into the interior of the searchlight under stress of weather.

### BACKGROUND OF THE PRESENT INVENTION

1. Field of the Present Invention

The invention relates to an improvement on searchlight, more particularly to a searchlight has a wireless receiver with its assembling position outside and away from the searchlight.

2. Description of Prior Act

An example of a remote-controlled searchlight as shown in FIG. 1 is known from U.S. Pat. No. 4,930,057 to J. L. Williams, which is disclosed the remote-controlled searchlight permanently mounted to a supporting surface, such as the roof of a car or the deck of a boat, and a remote-control box capably being placed inside of a vehicle to permit the vehicle operator to switch the searchlight on and off as well as to undergo sweeping movement in both vertical and horizontal directions.

In this patent there is described a searchlight 10 which comprises a lamp housing 20 constituted by an upper housing 21 and a lower housing 22 with an integrally formed ring gear 25; a base means 30 for mounting the lamp housing 20, which has a flange 31 with several holes 32 formed for permanently mounting the base 30 by means of screws to a supporting surface for the searchlight 10; a lamp means 40 mounted in the lamp housing 20 for vertical movement, which includes a bulb housing 41 with a bearing means for mounting in the lamp housing 20 and a vertical gear member 43 integrally formed on back of the bulb housing 41; a vertical drive means 50 mounted in the lamp housing 20 for vertically driving the lamp means 40, which includes a reversible gear motor 51 having an output shaft with pinion means 52 for engaging the vertical gear member 43 of the lamp means 40; a horizontal drive means 60 mounted in the base means 30 for driving the lamp means 40 and lamp housing 20 in a horizontal plane less than 360 degrees, which includes a reversible gear motor 61 having an output shaft with a pinion means 62 for engaging the ring gear 25 of the lamp housing 20; and an electrical cable 70 with leads 71, 72 and 73 as power source extended from the lamp housing 20 and the base means 30 into a remote-control box placed inside of a vehicle, so that a bulb installed in the bulb housing 41 is connected by leads 71 to a 12-volt DC power source, the reversible gear motor 51 is connected by leads 72 to a 12-volt DC power source and the reversible gear motor 61 is connected by leads 73 to a 12-volt DC power source.

The remote-controlled searchlight 10 mentioned above is very convenient in use, but the remote-controlled searchlight 10 can not be remotely operated by wireless control, and the remote-controlled searchlight 10 is short of a waterproof cover to prevent rain water from seeping into the interior of the remote-controlled searchlight 10 through a gap 28 is existed in between the lamp means 40 and the lamp housing 20, so that the remote-controlled searchlight 10 is easily happened to break down under stress of weather.

Another example of a wireless remote-controlled searchlight is known from U.S. Pat. No. 5,673,989 to Gohl et al. Although most mechanical structures of the wireless remote-controlled searchlight are similar to that of U.S. Pat. No. 4,930,057 mentioned above, the remote control for the searchlight is preferably provided by a hand-held multichannel radio transmitter and a locally mounted receiver contained within a lamp housing of the searchlight. The transmitter and receiver circuits control the reversible gear motor in the lamp housing for vertical and horizontal rotational movement of the lamp and the power to the lamp filament.

Due to the receiver mounted inside the lamp housing of the searchlight and closed to the reversible gear motor, the RF transmitted from the transmitter is easily jammed by interference from the reversible gear motor, resulted in the wireless remote-controlled searchlight is frequently hard to remotely control by wireless control.

Similarly, the wireless remote-controlled searchlight is still short of a waterproof cover, likewise the rain water shall seep into the interior of the searchlight through a gap existed due to a lamp means installed inside the lamp housing with, vertical rotational movement, so that the wireless remote-controlled searchlight is easily happened to break down under stress of weather.

### SUMMARY OF THE INVENTION

Therefore, the main object of the present invention is to provide a searchlight permanently positioned on the roof of a vehicle or the deck of a boat, wherein a lamp means is mounted in a lamp housing having a vertical drive means for tilting the lamp means in a vertical direction and a horizontal drive means for rotating the lamp means in a horizontal direction, the vertical and horizontal drive means are wireless remote-controlled via a wireless receiver and two separated wireless transmitters, particularly, the wireless receiver is assembled on an electrical cable as power source for the searchlight with a assembling position outside and away from the searchlight to prevent radio interference from the vertical and horizontal drive means, one of the two separated wireless transmitters is connected by leads of the electrical cable to a 12-volt DC power source supplied from the vehicle through a plug or the boat battery and is placed inside of the vehicle or the boat to permit the vehicle or boat operator to switch the searchlight on and off as well as to undergo sweeping movement in both vertical and horizontal directions, and the other wireless transmitters by power source supplied from 9-volt DC battery is portable and remotely operated from a distance from the vehicle or the boat while the vehicle or the boat is parked.

The advantage for this present invention is easy to wireless remotely control with great precision due to the receiver being prevented from radio interference caused from the vertical and horizontal drive means of the searchlight.

Another object of this present invention is to provide a waterproof cover to prevent rain water from seeping into the interior of the searchlight, so that the searchlight of the invention shall be always kept in normal use under stress of weather.

### BRIEF DESCRIPTION OF THE DRAWINGS

Other features and advantages of the present invention will become apparent in the following detailed description of the preferred embodiments with reference to the accompanying drawings, of which:

FIG. 1 is a partial cross sectional side view of the remote-controlled searchlight according to U.S. Pat. No. 4,930,057; and

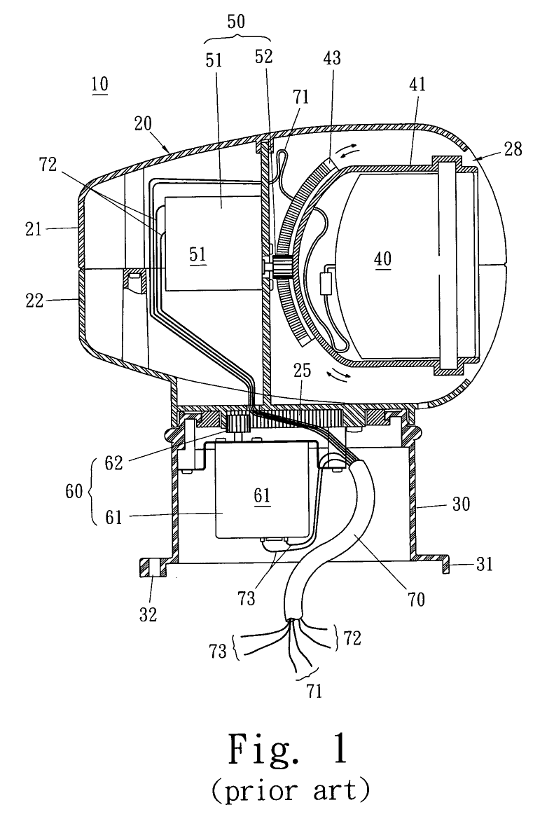

FIG. 2 is a partial cross sectional side view of the invented searchlight according to the invention.

### DETAILED DESCRIPTION OF THE PREFERRED EMBODIMENTS

Before the present invention is described in greater detail, it should be noted that like elements are denoted by the same reference numerals throughout the disclosure.

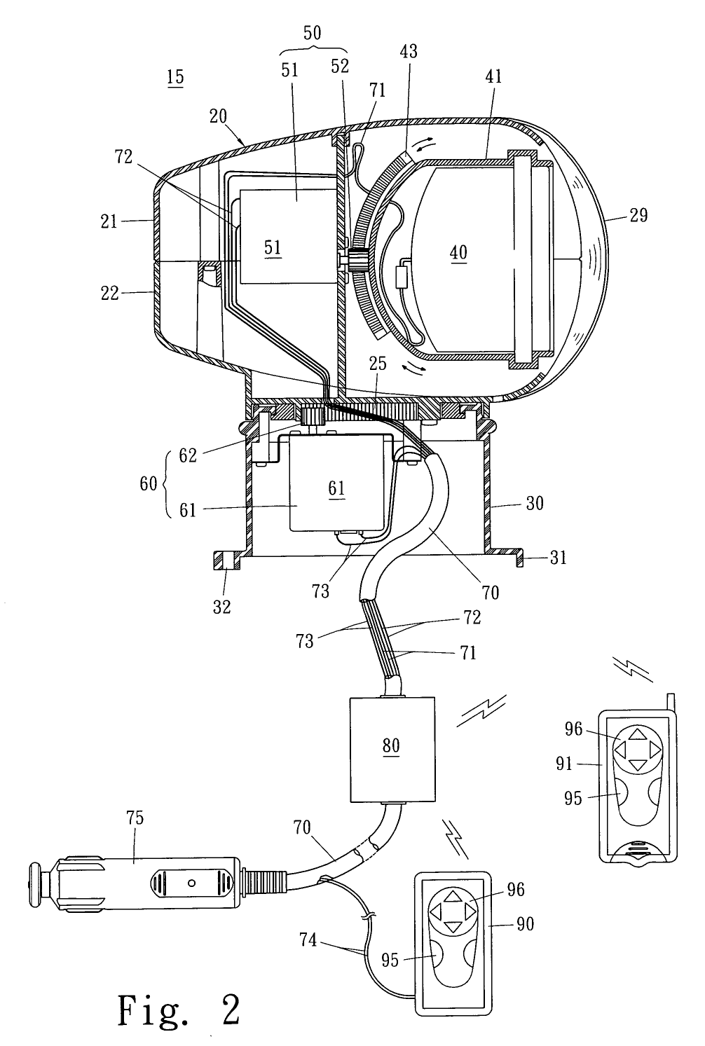

Referring to FIG. 2, the preferred embodiment of a wireless remote-controlled searchlight 15 of the present invention is permanently positioned on the roof of a vehicle or the deck of a boat, which comprises a lamp housing 20, a base means 30, a lamp means 40, a vertical drive means 50, a horizontal drive means 60, an electrical cable 70 with a plug 75 and four leads 71, 72, 73, and 74 as power source for the searchlight 15, a wireless receiver 80 assembled on the electrical cable 70 with a assembling position outside and away from the lamp housing 20 and the base means 30, and two separated wireless transmitters 90 and 91.

The lamp housing 20 is constituted by an upper housing 21 and a lower housing 22 which is provided with an integrally formed ring gear 25.

The base means 30 for mounting the lamp housing 20 has a flange 31 extended from its bottom and plural fasten holes 32 formed on the flange 31 applied for permanently mounting the base 30 by means of screws to the roof of a vehicle or the deck of a boat.

The lamp means 40 with a bulb is pivotedly mounted in the lamp housing 20 for vertical movement, which includes a bulb housing 41 with a bearing means for mounting in the lamp housing 20 and a vertical gear member 43 integrally formed on back of the bulb housing 41. And, the bulb of the lamp means 40 is connected by leads 71 of the electrical cable 70 to a 12-volt DC power source.

The vertical drive means 50 is mounted in the lamp housing 20 as shown in FIG. 2 for vertically driving the lamp means 40, which includes a reversible gear motor 51 having an output shaft with pinion means 52 for engaging the vertical gear member 43 of the lamp means 40. And, the reversible gear motor 51 is connected by leads 72 of the electrical cable 70 to a 12-volt DC power source.

The horizontal drive means 60 is mounted in the base means 30 for driving the lamp means 40 and lamp housing 20 in a horizontal plane less than 360 degrees, which includes a reversible gear motor 61 having an output shaft with a pinion means 62 for engaging the ring gear 25 of the lamp housing 20. And, the reversible gear motor 61 is connected by leads 73 of the electrical cable 70 to a 12-volt DC power source.

The electrical cable 70 is a 12-volt DC power source which power source is supplied from the vehicle through the plug 75 or from the boat battery.

The wireless receiver 80 is a kind of three channel receiver which has an antenna inside to receive the RF transmitted from the wireless transmitters 90 or 91 to proceed with wireless remote control. One channel is provided for turning power to the bulb of the lamp means 40 on and off and “on” standby power to the reversible gear motor 51 and 61. One channel is used for tilting the lamp means 40 in a vertical direction via the vertical drive means 50, and the third channel is used for rotating the lamp means 40 in a horizontal direction via the horizontal drive means 60.

Due to the wireless receiver 80 assembled on the electrical cable 70 with a assembling position outside and away from the lamp housing 20 and the base means 30, the wireless receiver 80 shall be prevented from radio interference caused from the vertical drive means 50 and horizontal drive means 60, so that this present invention has the advantage of being easy to wireless remotely control with great precision.

The wireless transmitter 90 includes an on/off switch 95 and a four-way directional control switch 96. The wireless transmitter 90 is connected by leads 74 of the electrical cable 70 to a 12-volt DC power source, so that the wireless transmitter 90 is capable of being placed inside of a vehicle or a boat, while the vehicle or the boat is in operation, to permit the vehicle or boat operator by way of remote control to switch the searchlight 15 on and off as well as to undergo sweeping movement in both vertical and horizontal directions.

The other wireless transmitter 91 includes an on/off switch 95 and a four-way directional control switch 96 too, which is powered by a replaceable internal power supply; for example, a 9-volt battery. Therefore, the wireless transmitter 91 is portable and remotely operated from a distance from the vehicle or the boat while the vehicle or the boat is parked.

Another preferred embodiment of wireless remote-controlled searchlight 15 of this present invention is further provided with a waterproof cover 29 which is securely assembled on the lamp housing 20 and positioned in front of the lamp means 40 to cover the gap existed due to the lamp means 40 installed inside the lamp housing 20 with vertical rotational movement.

With the waterproof cover 29, the wireless remote-controlled searchlight 15 of this present invention has function of preventing rain water from seeping into the interior of the searchlight 15, so that the searchlight 15 of the invention shall be always kept in normal use under stress of weather.

What is claimed is:

1. A searchlight improvement structure comprising:
an electrical cable with a plug and four leads to supply power source to the searchlight;
a lamp housing constituted by an upper housing and a lower housing with an integrally formed ring gear;
a base means for mounting the lamp housing;
a lamp means for pivotedly mounting in the lamp housing for vertical movement, which includes a bulb housing with a bulb connected by leads of the electrical cable and a vertical gear member integrally formed on back of the bulb housing;
a vertical drive means mounted in the lamp housing for vertically driving the lamp means, which includes a reversible gear motor connected by leads of the electrical cable having an output shaft with a pinion means for engaging the vertical gear member of the lamp means;
a horizontal drive means mounted in the base means for driving the lamp means and lamp housing in a horizontal plane, which includes a reversible gear motor connected by leads of the electrical cable having an output shaft with a pinion means for engaging the ring gear of the lamp housing;
a wireless receiver with an antenna inside being a kind of three channel receiver assembled on the electrical cable with its assembling position outside and away from the lamp housing and the base means, and
two separated wireless transmitters each include an on/off switch and a four-way directional control switch, one wireless transmitter is connected by leads of the electrical cable, the other wireless transmitter is powered by a replaceable internal power supply.

2. The searchlight improvement structure as defined in claim 1, the base means has a flange extended from its bottom and plural fasten holes formed on the flange.

3. The searchlight improvement structure as defined in claim 2, wherein a waterproof cover is securely assembled on the lamp housing and positioned in front of the lamp means to prevent water from seeping into the interior of the searchlight.
